(19) United States
(12) Patent Application Publication
(10) Pub. No.: US 2024/0142194 A1
(43) Pub. Date: May 2, 2024

(54) Energy Bow Actuator and Launcher

(71) Applicants: Ryan Thomas Kinback, Wilmore, PA (US); Nicolas Craig Kinback, Wilmore, PA (US); Cody James Kinback, Wilmore, PA (US)

(72) Inventors: Ryan Thomas Kinback, Wilmore, PA (US); Nicolas Craig Kinback, Wilmore, PA (US); Cody James Kinback, Wilmore, PA (US)

(21) Appl. No.: 17/974,502

(22) Filed: Oct. 26, 2022

(51) Int. Cl. F41B 5/00; F16H 21/06

(52) U.S. Cl. CPC F41B 5/0094; F16H 21/06

(57) ABSTRACT

Levers with fulcrums and other linkages can be structured to provide motion in many different structural formations by making adjustments to the parameters of a mechanism such as this invention. Mechanisms with multiple levers working together in coordination and moving a fraction of the full actuation allows machines to be built more efficiently. The levers can be connected to each other in multiple configurations which allow for these machines to be built and programmed from how the levers are connected to each other. This invention is modular so building complex actuators is a simple procedure. The machine can be used as a mechanical actuator or a projectile launcher or a programmable moving mechanism where the programming is built in the structure. By using levers, and simple energy mechanisms to power this invention, the overall efficiency of some processes can be increased.

### CROSS-REFERENCE TO RELATED APPLICATIONS

Provisional application No. 63/271,715, filed on Oct. 26, 2021

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The present invention is in the field of projectile launchers and actuators. More specifically, the present invention relates to cars, boats, planes, machines, excavators, and any type of moving mechanism. The present invention actuates similar to how a bow flexes except in this invention the bow part is made up of small sub sections and flexed by a force acting on levers in each sub section.

The present invention makes use of levers and modular components to increase efficiency of machines that move. The present invention is modular and a simple procedure with a small number of unique parts can be used to put the structure together, and it is also mechanically programmable because by changing a set of parameters in the overall structure, the machine will move in a new and predictable way. The present invention allows for another form of launching projectiles and moving any type of machine. The present invention can be used as an electrically powered computer controlled automatic bow and arrow. As a simple actuator the present invention can be used in mechanism for more efficient control and builds.

### BRIEF SUMMARY OF INVENTION

The present invention is an actuator that uses force applied to as many levers as possible to make the invention as efficient as possible for a specific use. The present invention will be referred to from here as E-Bow, which stands for Electric Bow or Energy Bow as various sources of energy can be used as the applied force to the mechanical structure. The E-Bow is made up of sub units attached together to form an array of the sub units. An array can consist of a single sub unit. And each of the sub units contain two levers that pivot around the same pivot point, and the two levers are controlled by an applied force on the levers effort side and that force separates the levers with a larger angle between them as they rotate, or the force brings the levers closer together or moves them further apart. A cross linkage also connects one side of the structure to the other side of the structure with degrees of freedom so as the forces act on the levers than the cross linkage moves relative to the position of the levers. The force can be applied from a number of different sources, such as, a magnetic field pushing and pulling the two levers, or a hydraulic linear actuator that extends and contracts between the two levers, or pneumatics, or springs and other types of force mechanism. Each of the sub units are attached to a neighbor sub unit by connecting levers of sub units together. Because the sub units are attached in this way, when the force is applied to each of the sub unit actuators, the levers move apart and the line of sub units forms a bow shape because the angle between each lever is adding to the curve structure of the flex. When the actuator is turned to contract, then the levers of each sub unit move together and all of the sub units line back up in the starting position. This form of motion gives actuation in multiple directions simultaneously. The described motion of the E-Bow between the extended and contracted states of the sub unit actuators gives the machine the ability to be an actuator or launch a projectile as a bow launches an arrow. The overall power of the actuation is the power of one sub unit actuators multiplied by a factor that depends on the number of sub units, weight of sub units, angle of actuation, the distance between each sub unit, and the relative positions of the sub units to the other sub units. The E-Bow is capable of adding more power by placing sub units in parallel with each other, so that the sub units in parallel with each other are also connected to the same neighbor sub units. With multiple E-Bows connected in series, the overall actuation can be increased. Multiple E-Bows and sub units of E-Bows can be attached in different configurations. One configuration is a coil configuration, where each sub unit of the E-Bow is connected so that it is elevated from the previous sub unit, then when multiple of sub units are added in this way, an E-Bow will form a coil formation when it is in a flexed state, and that coil will straighten when the E-Bow is not flexed. There are a lot of configurations that can be made by attaching E-Bows and sub units of E-Bows together, and these configurations can be used to provide actuation in a unique and novel way.

### BRIEF DESCRIPTION OF THE SEVERAL VIEWS OF THE DRAWINGS

FIG. 1—Top View of E-Bow in a Not Flexed State

FIG. 2—Structural Linkage of a Sub Unit of an E-Bow

FIG. 3—Top View of E-Bow in a Flexed State with Projectile Launcher Mechanism

FIG. 4—Side View of E-Bow in a Flexed State with Projectile Launcher Mechanism

FIG. 5—Alternate Form of Structural Linkage of a Sub Unit of an E-Bow

### DETAILED DESCRIPTION OF THE INVENTION

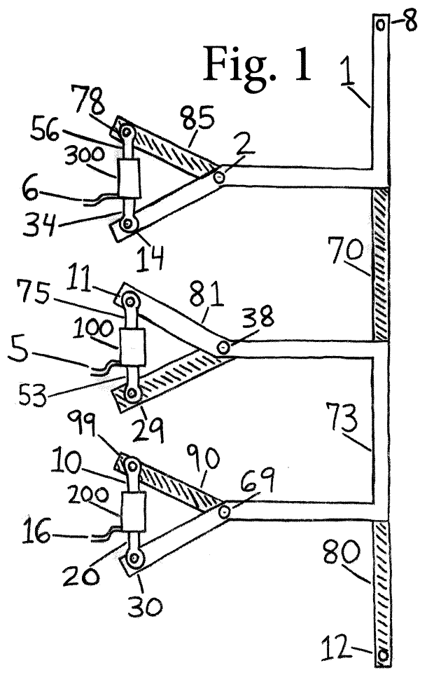

The present invention as shown in FIG. 1 is made up of Sub Unit 85, Sub Unit 81, and Sub Unit 90. Each of these sub units consist of similar parts, and the sub units are connected with the neighbor sub unit. Sub Unit 81 shares Structural Linkage 70 with Sub Unit 85, and it also shares Structural Linkage 73 with Sub Unit 90. Structural Linkage 70 and Structural Linkage 73 can be made from rigid materials such as plastic, wood, steel and is used as a solid structural frame and lever arms for the invention. Sub Unit 81 is also made up of Actuator 100 and Actuator Power 5. Actuator 100 can be a magnetic linear actuator, or a rail-gun made into a linear actuator for some applications, hydraulic actuator, pneumatic actuator, or other forms of actuators, such as the present invention. The Actuator Power 5 is electrical wiring for the magnetic actuator or it would be a fluid or air line for hydraulic or pneumatic versions, or other power sources. Actuator 100 also has an Actuator Right Arm 53 and Actuator Left Arm 75, which provide the connection points for the Actuator 100 and the Structural Linkage 70 and Structural Linkage 73. The Actuator Right Arm 53 has an Actuator Right Arm Pivot Point 29, which connects the Actuator 100 to Structural Linkage 70 and allows Actuator 100 to rotate around Actuator Right Arm Pivot Point 29 while connected to Structural Linkage 70. The Actuator Left Arm 75 has an Actuator Left Arm Pivot Point 11, which connects the Actuator 100 to Structural Linkage 73 and allows Actuator 100 to rotate around Actuator Left Arm Pivot Point 11 while connected to Structural Linkage 73. Both Actuator Left Arm Pivot Point 11 and Actuator Right Arm Pivot Point 29 can made of cylindrical bearings and shaft, or hole with a shaft through the center. Sub Unit 81 has a Linkage Pivot 38, which connects Structural Linkage 70 and Structural Linkage 73 so that they rotate freely around the center of Linkage Pivot 38. Linkage Pivot 38 is a fulcrum for the two levers it connects. Structural Linkage 70 and Structural linkage 73 are on top of each other and separated so that they can freely rotate. Linkage Pivot 38 can also be made from a cylindrical bearing with Structural Linkage 70 connected to the outside of the cylindrical bearing and Structural Linkage 73 connected with a shaft to the center of the bearing. Linkage Pivot 38 in simplest form is a hole cut into the material for Structural Linkage 70 and Structural Linkage 73 with a bolt through the center that has a nut holding the parts loosely onto the bolt, and a separator, like washer, between Structural Linkage 70 and Structural Linkage 73.

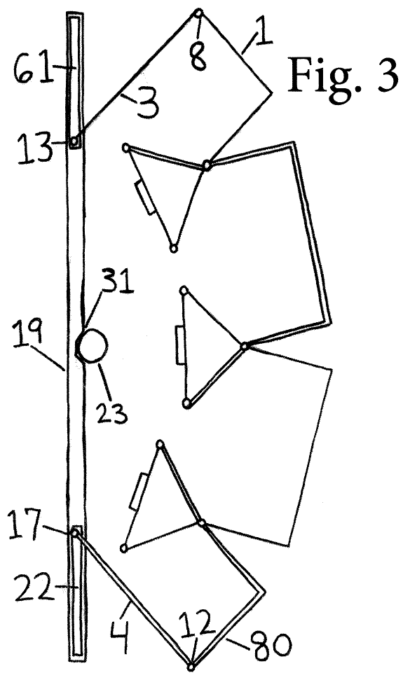

Sub Unit 85 shares Structural Linkage 70 with Sub Unit 81, and it also shares Structural Linkage 1 with either another sub unit that is not shown, or in this case Structural Linkage 1 has Left Connecting Point 8 as a connection point for either projectile launching as shown in FIG. 3 or for actuation. Structural Linkage 70 and Structural Linkage 1 can be made from rigid materials such as plastic, wood, steel and is used as a solid structural frame and lever arms for the invention. Sub Unit 85 is also made up of Actuator 300 and Actuator Power 6. Actuator 300 can be a magnetic linear actuator, hydraulic actuator, pneumatic actuator, or other forms of actuator such as the present invention. The Actuator Power 6 is electrical wiring for the magnetic actuator or it would be a fluid or air line for hydraulic or pneumatic versions. Actuator 300 also has an Actuator Right Arm 34 and Actuator Left Arm 56, which provide the connection points for the Actuator 300 and the Structural Linkage 1 and Structural Linkage 70. The Actuator Right Arm 34 has a Actuator Right Arm Pivot Point 14, which connects the Actuator 300 to Structural Linkage 1 and allows Actuator 300 to rotate around Actuator Right Arm Pivot Point 14 while connected to Structural Linkage 1. The Actuator Left Arm 56 has a Actuator Left Arm Pivot Point 78, which connects the Actuator 300 to Structural Linkage 70 and allows Actuator 300 to rotate around Actuator Left Arm Pivot Point 78 while connected to Structural Linkage 70. Both Actuator Left Arm Pivot Point 78 and Actuator Right Arm Pivot Point 14 can made of cylindrical bearings and shaft or hole with a shaft through the center. Sub Unit 85 has a Linkage Pivot 2, which connects Structural Linkage 70 and Structural Linkage 1 so that they rotate freely around the center of Linkage Pivot 2. Structural Linkage 70 and Structural linkage 1 are on top of each other and separated so that they can freely rotate. Linkage Pivot 2 can also be made from a cylindrical bearing with Structural Linkage 70 connected to the outside of the cylindrical bearing and Structural Linkage 1 connected with a shaft to the center of the bearing.

Sub Unit 90 shares Structural Linkage 73 with Sub Unit 81, and it also can share Structural Linkage 80 with either another sub unit that is not shown, or in this case Structural Linkage 80 has Right Connecting Point 12 as a connection point for either projectile launching as shown in FIG. 3 or for actuation. Structural Linkage 73 and Structural Linkage 80 can be made from rigid materials such as plastic, wood, steel and is used as a solid structural frame and lever arms for the invention. Sub Unit 90 is also made up of Actuator 200 and Actuator Power 16. Actuator 200 can be a magnetic linear actuator, hydraulic actuator, pneumatic actuator, or other forms of actuator such as the present invention. The Actuator Power 16 is electrical wiring for the magnetic actuator or it would be a fluid or air line for hydraulic or pneumatic versions. Actuator 200 also has an Actuator Right Arm 20 and Actuator Left Arm 10, which provide the connection points for the Actuator 200 and the Structural Linkage 73 and Structural Linkage 80. The Actuator Right Arm 20 has a Actuator Right Arm Pivot Point 30, which connects the Actuator 200 to Structural Linkage 73 and allows Actuator 200 to rotate around Actuator Right Arm Pivot Point 30 while connected to Structural Linkage 73. The Actuator Left Arm 10 has a Actuator Left Arm Pivot Point 99, which connects the Actuator 200 to Structural Linkage 80 and allows Actuator 200 to rotate around Actuator Left Arm Pivot Point 99 while connected to Structural Linkage 80. Both Actuator Left Arm Pivot Point 99 and Actuator Right Arm Pivot Point 30 can made of cylindrical bearings and shaft or hole with a shaft through the center. Sub Unit 90 has a Linkage Pivot 69, which connects Structural Linkage 73 and Structural Linkage 80 so that they rotate freely around the center of Linkage Pivot 69. Structural Linkage 73 and Structural linkage 80 are on top of each other and separated so that they can freely rotate. Linkage Pivot 69 can also be made from a cylindrical bearing with Structural Linkage 73 connected to the outside of the cylindrical bearing and Structural Linkage 80 connected with a shaft to the center of the bearing. The invention is not limited to three sub units, but could be made up of any number of sub units connected in a similar method as the three sub units are shown in FIG. 1. The invention can also have any number of sub units connected to other sub units at various angles, in various planes, and different positions on each lever.

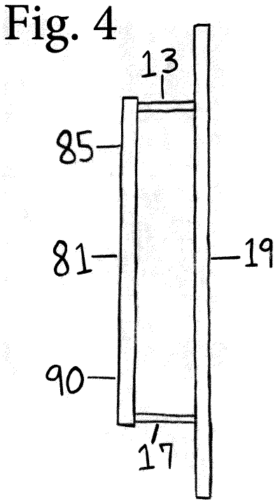

A mechanism is shown in FIG. 3 for the invention to work as a projectile launcher, and this same mechanism in FIG. 3 can be adapted to make the invention work as an actuator. FIG. 3 shows how the invention can be used to launch something in the same way a bow launches an arrow, the present invention has a Sliding Launch Bar 19. At the center of Sliding Launch Bar 19 is Projectile Seat 31, which is a pocket to hold Projectile 23, just how a bow string holds an arrow or in a method that results in similar actions. At the right side of the Sliding Launch Bar 19 is a Right Sliding Pivot Point 17, and at the left side of the Sliding Launch Bar 19 is a Left Sliding Pivot Point 13. Right Sliding Pivot Point 17 is connected to Structural Linkage 4 so that Structural Linkage 4 can rotate around the center of Right Sliding Pivot Point 17. Left Sliding Pivot Point 13 is connected to Structural Linkage 3 so that Structural Linkage 3 can rotate around the center of Left Sliding Pivot Point 13. Right Sliding Pivot Point 17 is connected to Sliding Launch Bar 19 and inside of Right Groove Track 22, so that Right Sliding Pivot 17 can slide lengthwise in Sliding Launch Bar 19. Left Sliding Pivot Point 13 is connected to Sliding Launch Bar 19 and inside of Left Groove Track 61, so that Left Sliding Pivot 13 can slide lengthwise in Sliding Launch Bar 19. Right Sliding Pivot Point 17 can be a cylindrical bearing that fits in a slot in Right Groove Track 22 with a shaft connected to Structural Linkage 4. Left Sliding Pivot Point 13 can be a cylindrical bearing that fits in a slot in Left Groove Track 61 with a shaft connected to Structural Linkage 3. Structural Linkage 4 is similar material to Structural Linkage 70 and is, in this case, connected rigidly to Right Connection Point 12 and generally perpendicular to Structural Linkage 80. Structural Linkage 3 is similar material to Structural Linkage 70 and is, in this case, connected rigidly to Left Connection Point 8 and generally perpendicular to Structural Linkage 1. Shown in FIG. 4, a side view of the mechanism shows how Right Sliding Pivot Point 17 and Left Sliding Pivot Point 13 have shafts that extend upward so that the Sliding Launch Bar 19 is elevated above the plane of the Sub Unit 81, Sub Unit 85, and Sub Unit 90 so that they do not collide. The purpose of this launching mechanism that is shown in FIG. 3 is to move Sliding Launch Bar 19 and Projectile 23 forward when Structural Linkage 80 and Structural Linkage 1 move non-linearly back to the position that is shown in FIG. 1, pulling Sliding Launch Bar 19. FIG. 1 shows the mechanism with all of the sub-units lined up and FIG. 3 shows the mechanism flexed like a bow because all of the actuators are fully extended and causing the structural linkages to rotate as levers.

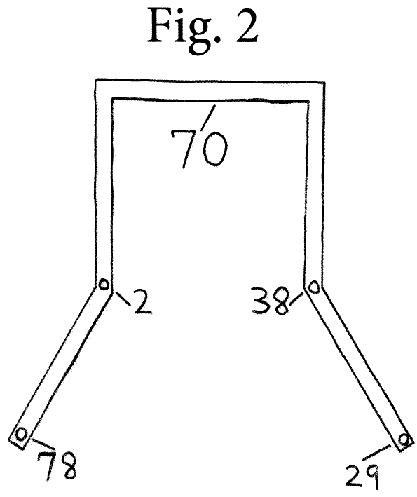

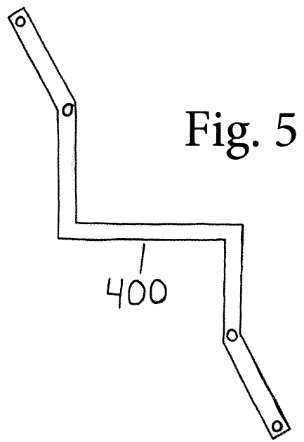

The invention works in the same way that a bow works. FIG. 1 shows the mechanism at the same point as a bow when an archer has not yet pulled back the string. FIG. 3 shows the invention at the same point as a flexed bow when the archer pulls back the string. The actuators, such as Actuator 100, do the work of the archer in pulling the bow back, but instead of pulling on the string, the actuators bend the structure of the bow, while the string remains tight or generally rigid. The present invention allows actuation in multiple directions depending on where the invention is fixed to a surface or a medium such as air and water. The invention can be held from either the top or bottom of the bow, giving one option for the direction of actuation, or it could be held from a central sub unit which would give another form of actuation. Sub units can be placed in parallel to other sub units to add more strength. The central sub unit could need more power because it is pulling both sides with all of the sub units together fully, so parallel would be a way to add strength in a modularly way. Multiple of the E-Bow could be connected in series at Right Connecting Point 12 and Left Connecting Point 8. Two of the E-Bow structures connected at these points would form a circular structure when flexed as in FIG. 3. Spiral and coil formations can also be made from the present inventions by connecting sub units in different simple configurations. Shown in FIG. 5 is Structural Linkage 400 that allows for the sub units to be connected in an alternating formation to allow for more space for the actuators. Shown in FIG. 2 is the Structural Linkage 70 form that allows for sub units to be connected on the same side such as in FIG. 1 and FIG. 3. Many other different structures can be built from adding multiple E-Bows together in various formations but all of these structures still use the structure of the E-Bow that is described.

In more detail the present inventions works by starting in the position shown in FIG. 1 with Actuator 100, Actuator 200 and Actuator 300 all at their shortest length of actuation. As power is applied to the actuators, either simultaneously, semi-simultaneously, or cascading, the Actuator 100, Actuator 200, and Actuator 300 all extend their arms outward. By Actuator 100 extending outward, Actuator Right Pivot 29 and Actuator Left Pivot 11 move away from each other, and Actuator 100 moves toward Linkage Pivot 38. Actuator Right Pivot 29 pushes Structural Linkage 70 around Linkage Pivot 38 and Actuator Left Pivot 11 pushes Structural Linkage 73 around Linkage Pivot 38. Structural Linkage 70 and Structural Linkage 73 form an angle between each other as Actuator 100 moves, and this is what flexes the bow. By Actuator 200 and Actuator 300 working the same way as Actuator 100, all of the structural linkages move apart and allow for the Projectile 23 to move to the position as shown in FIG. 3. Then when Actuator 200, Actuator 300, and Actuator 100 all contract the bow moves back to the position in FIG. 1 and the Projectile 23 is also moved forward. The total distance of actuation for the present invention depends on the angles the actuators push the structural linkages apart, the distance between each sub unit as determined by the structural linkages and the total number of sub units connected in the same way as shown in FIG. 1 and FIG. 3. Because of the simple structure of each sub unit, small building materials can be used to make the structural linkages with small magnetic or heat elements as the actuators, and this would allow actuators to be printed how computer chips are made, which would allow for blocks of actuators to be made with various dimensional properties.

The E-Bow launches projectiles such as arrows, or it launches ground, air, water, or another substance and travels on the ground, in the air, water or other substance. A simple adjustment on FIGS. 1 and 3 will turn the present invention from a machine that launches a projectile to a machine that travels on the ground. To make this adjustment, turn Projectile 23 into a hydraulic cylinder with the actuation direction perpendicular to Sliding Launch Bar 19 and into the paper, and with the hydraulic cylinder attached rigidly to Projectile Seat 31. Also, add another hydraulic cylinder in the same orientation as the previous but attached rigidly to Actuator 100 in a way so that it does not affect the motion of the machine. Both of the hydraulic actuators are controlled to contract or extend. The E-Bow can travel on the ground by the following sequence. The position of the E-Bow in FIG. 1 has the hydraulic cylinder attached to Actuator 100 in the up position so that the cylinder is not contacting the ground at the same time the hydraulic cylinder attached to Projectile Seat 31 is in the down position and contacting the ground. The E-Bow activates and flexes into the position shown in FIG. 3, and as it flexes Actuator 100 is moved further in front of Projectile Seat 31 and Projectile Seat 31 stayed in about the same position relative to the Earth because the hydraulic cylinder attached to Projectile Seat 31 is in contact with the ground, like dragging a plow in a field. Now that the E-Bow is in the position shown in FIG. 3, they two hydraulic cylinders actuate so that the cylinder in the ground is now up off of the ground and the cylinder that was off of the ground is now contacting the ground. The E-Bow then straightens out again and since the hydraulic cylinder that is attached to Projectile Seat 31 is up off of the ground, the un-flex causes the entire structure attached to Projectile Seat 31 to move forward relative to the starting position on the ground. The hydraulic cylinder attached to Actuator 100 is down and digging into the ground so as the present invention flexes and straightens, it moves the entire structure over the ground so that it can travel. Similar adjustments can be made for air or water or another substance. With similar adjustments, the E-Bow can move other mechanical structures that are attached to the E-Bow. Along with the machines described using the E-Bow, there are many other machines that can be built with the same invention. There are many other uses and configurations of this invention that are not mentioned in this specification but still part of this invention. Many of these configurations and uses, that are not mentioned here, can be seen using three dimensional simulations that can be made by altering parameters of the E-Bow structure, components, and the connections between components.

While the present embodiment of the invention is described, the invention is not limited thereto, but may otherwise be embodied, built, and used with the scope of the following claims.

What is claimed is:

1. A mechanical structure consisting of:
at least two levers with the pivot point on the same fulcrum;
a force that pulls or pushes one side of each lever so that the said levers generally become closer to parallel or closer to perpendicular relative to each other, like how scissors move;
a cross bar that connects at least two levers together in a way so that the said cross bar can rotate around the point where the said cross bar connects to a lever;
a point of connection between the said cross bar and one lever, which can move toward or away from the connection point that is between another lever and the said cross bar;
a motion that results when a pulling force is applied to the levers such that the levers move closer together and each lever rotates about the same said fulcrum and as the said levers move on the said fulcrum, both of the said connection points move closer together and the angle between the said cross bar and a lever which the said cross bar is connected to changes;
a motion that results when a pushing force is applied to the levers such that the levers move further apart, and each lever rotates about the same said fulcrum, and as the said levers move on the said fulcrum, both of the said connection points move further apart, and the angle between the said cross bar and a lever which the said cross bar is connected to changes;
a change in the distance that is measured between a point on the said cross bar and the position of at least one fulcrum, and that said distance change is a result of the said pushing and said pulling of the said levers.

2. A mechanical structure as described in claim 1, wherein the said mechanical structure is made of an array, or multitude of the said mechanical structures linked together by attaching a said lever of each said mechanical structure to another said lever of another said mechanical structure that is in the said array, or multitude.

3. A structure consisting of;
multiple sub-structures where each sub-structure is composed of at least two levers crossed and connected to the same fulcrum, and a force that pulls or pushes the effort side of each lever so that the said levers rotate about the said fulcrum, like scissors;
a lever of a said sub-structure is connected to the lever of another said sub-structure;
a mechanical cross linkage that has a connection point with a lever of one sub-structure and the said mechanical cross linkage has another connection point with a lever of another sub-structure;
a rotational degree of freedom at each said connection point between a lever and the said mechanical cross linkage;
ability to have movement and a change of distance between the connection point where the said mechanical cross linkage attaches to the said lever and the connection point where the said mechanical cross linkage attaches to another lever in the said sub-structure;
a movement result where the said mechanical cross linkage moves closer or further from a said fulcrum of at least one of the said sub-structures when a force is applied to at least one of the levers of a said sub-structure.

4. The invention as described in claim 3, where there is a coordination between the forces acting on the said levers of the said sub-structure in the said structure.

5. The invention as described in claim 3, where sub-structures are connected to other sub-structures in a parallel arrangement or in a series arrangement or in both arrangements to make up one said structure.

6. The invention as described in claim 3, where said structures that are made up of multiple said sub-structures are connected to other said structures in a parallel arrangement or in a series arrangement or in both arrangements.

7. The invention as described in claim 3, where there is at least one attachment point on the said mechanical cross linkage for another mechanical object to make contact.

8. The invention as described in claim 3, where there is at least one attachment point on a said fulcrum on any said sub-structure for another mechanical object to make contact.

9. The invention as described in claim 3, where there is at least one attachment point on at least one said lever where another mechanical object can make contact.

10. The invention as described in claim 3, where the said mechanical cross linkage moves a piston as said push and said pull forces are applied to said levers of said sub-structures.

11. The invention as described in claim 3, where the said mechanical cross linkage launches an object as a result of said push and said pull forces that are applied to said levers of said sub-structures.

12. The invention as described in claim 3, where the said mechanical cross linkage is the fixed point and the said sub-structures moves a piston as said push and said pull forces are applied to said levers of said sub-structures.

13. The invention as described in claim 3, where the said mechanical cross linkage is a fixed point and the said sub-structures launch an object as a result of said push and said pull forces that are applied to said levers of said sub-structures.

14. The invention as described in claim 3, where the levers of the said sub-structures are connected to other said sub-structures so that the said sub-structures are aligned in generally the same plane.

15. The invention as described in claim 3, where the levers of the said sub-structures are connected to other said sub-structures so that the said sub-structures are aligned angularly to each other.

16. The invention as described in claim 3, where a location on the said structure that is near to one of the said connection points of the said mechanical cross linkage is fixed in position and the remaining part of the said structure is free to move.

17. The invention as described in claim 3, where at least one component of one of the said sub-structures is fixed in position and the remaining components of the said structure are free to move.

18. The invention as described in claim 3, where the structure moves through a medium when applying said push and said pull forces to said sub-structures said levers by switching between two fixed points on the said structure where the point on the said structure that is in a fixed position relative to the said medium is determined by if the said force is pushing or pulling the said levers while the other fixed point of the said two fixed points is unfixed so that part of the structure moves through the said medium while the other part of the structure is fixed in position and then as the said force switches from either said push or said pull, then the opposite said fixed position of the said two fixed positions is fixed while the said position that was fixed is free to move through the said medium.

19. The invention as described in claim 3, where at least one said sub-structure is connected to another said sub-structure by a linkage that is at least partially rigid.
